(19) United States
(12) Patent Application Publication
(10) Pub. No.: US 2019/0149061 A1
(43) Pub. Date: May 16, 2019

(54) Power source device of electric tool

(71) Applicant: Renun Mechanical & Electrical Co., Ltd, Zhuji, Zhejiang (CN)

(72) Inventors: Kewei Wang, Zhuji, Zhejiang (CN); Ruiguang Wen, Zhuji, Zhejiang (CN)

(21) Appl. No.: 15/025,561

(22) PCT Filed: Aug. 26, 2015
(86) PCT No.: PCT/CN2015/088127

§ 371 Date: Mar. 29, 2016

(30) Foreign Application Priority Data
Jul. 14, 2015 (CN) 201510411538.6
Jul. 14, 2015 (CN) 201520508222.4

(51) Int. Cl. H02M 7/12; B66D 1/12; H02M 1/32

(52) U.S. Cl. CPC H02M 7/12; H02M 1/32; B66D 1/12

(57) ABSTRACT

A power source device of an electric tool includes: a power source module, including a short circuit protection circuit, a filter circuit, a start circuit and a rectifier filter circuit, wherein the power source module converts an inputted AC (alternating current) into a high voltage DC (direct current) through the short circuit protection circuit, the filter circuit, the start circuit and the rectifier filter circuit; a driving module, including an H bridge circuit, a control circuit, a protection circuit and a control power source, wherein the driving module divides the high voltage DC into a first DC and a second DC; and a power cable, respectively connected to the power source module and the driving module, for sending the high voltage DC from the power source module to the driving module.

### CROSS REFERENCE OF RELATED APPLICATION

This is a U.S. National Stage under 35 U.S.C 371 of the International Application PCT/CN2015/088127, filed Aug. 26, 2015, which claims priority under 35 U.S.C. 119(a-d) to CN 201510411538.6, filed Jul. 14, 2015, and CN 201520508222.4, filed Jul. 14, 2015.

### BACKGROUND OF THE PRESENT INVENTION

### Field of Invention

The present invention relates to a technical field of power sources of motors, and more particularly to a power source device of a brushless DC motor used by an electric tool.

### Description of Related Arts

According to a circuit structure of a brushless DC motor, the brushless DC motor not only needs a high voltage DC power source for supplying motor coils, but also needs a control power source for supplying each control circuit. Only when the two kinds of power sources work at the same time, the motor is able to work normally. When using 220V AC as the power source of the motor, the 220V AC should be rectified and filtered so as to obtain the high voltage DC power source for supplying the motor coils. Meanwhile, the control power source is obtained through a buck chopper which lowers the voltage. Due to the structure of the brushless DC motor is compact and a space thereof is limited, the high voltage DC power source and the control power source are placed outside a main body of the brushless DC motor; then the main body of the brushless DC motor, the high voltage DC power source and the control power source are connected through no less than two sets of power cables, so as to form a complete brushless DC motor. There are two problems in actual use of the above motor scheme. Firstly: because the power cables connecting the main body of the brushless DC motor, the high voltage DC power source and the control power source are external arranged, the power cables are easy to be continuously pressed by an external force or cut by sharp metals, leading to short circuits of the high voltage DC power source and the control power source, so that the high voltage DC power source enters low voltage circuits without lowering the voltage, thereby immediately burning each control circuits. Secondly: when an application environment requires a long distance between the main body of the brushless DC motor and the external high-voltage DC power source as well as the control power source, the power cables therebetween must be long; however, when an output power of the brushless DC motor continuously increases, some losses will be caused due to parasitic inductance and resistance of the power cables, which means the parasitic inductance and resistance of the power cables will seriously lower a quality of the control power source, resulting large fluctuation of an output voltage and instability of an output current of the control power source, thereby affecting each control circuit on the brushless DC motor, and finally lowering performances of the brushless DC motor. Therefore, it is necessary to improve conventional technologies.

### SUMMARY OF THE PRESENT INVENTION

In order to solve the two problems of the above brushless DC motor power supply scheme, the present invention provides a novel power source device, which is able to not only effectively protect each control circuits even when a power cable of the blushless DC motor is continuously pressed by an external force or cut by sharp metals, which causes a short circuit happens inside the power cable; but also enable an output voltage and an output current of a control power source to be stable and reliable under conditions such as a large output power (of above 800 w) and a long power cable (of more than 3 m), so as to maintain stability and reliability of the brushless DC motor.

Accordingly, in order to accomplish the above object, the present invention provides a power source device of an electric tool, comprising:

a power source module, comprising a short circuit protection circuit, a filter circuit, a start circuit and a rectifier filter circuit, wherein the power source module converts an inputted AC (alternating current) into a high voltage DC (direct current) through the short circuit protection circuit, the filter circuit, the start circuit and the rectifier filter circuit;

a driving module, comprising an H bridge circuit, a control circuit, a protection circuit and a control power source, wherein the driving module divides the high voltage DC into a first DC and a second DC; the first DC is directly sent to the H bridge circuit as a power source of a motor coil, and the H bridge circuit outputs a voltage signal and a current signal for the motor coil according to a control signal; the second DC is sent to the control power source, then the control power source converts the second DC into a low voltage DC, for supplying the control circuit and the protection circuit; and

a power cable, respectively connected to the power source module and the driving module, for sending the high voltage DC from the power source module to the driving module.

Preferably, the power cable is a double-wire power cable.

Preferably, the power source module and the control power source are separately placed.

Preferably, the control power source is integrated in the driving module.

According to the present invention, the power source module converts the inputted AC into the high voltage DC, and the high-voltage DC is sent to the driving module through the double-wire power cable. Then the driving module divides the high voltage DC into the first DC and the second DC, wherein the first DC is directly sent to the H bridge circuit as the power source of the motor coil, and the H bridge circuit outputs the voltage signal and the current signal for the motor coil according to the control signal; the second DC is sent to the control power source, then the control power source converts the second DC into the low voltage DC, for supplying the control circuit and the protection circuit. With the foregoing structure, a high voltage DC power source and a control power source are able to be placed separately, and the power source module is connected to the driving module only with the double-wire power cable, in such a manner that when the power cable of a blushless DC motor is continuously pressed by an external force or cut by sharp metals and a short circuit happens inside the power cable, only the high voltage DC power source suffers from a short circuit, so as to effectively prevent the high voltage DC power source from entering low voltage circuits without lowering the voltage, which would immediately burn the control circuit and the protection circuit cases. Furthermore, because the control power source is integrated in the driving module, the control power source is no longer far from the control circuit and the protection circuit, so as to effectively protect the control power source from being affected by parasitic inductance and resistance on the power cable. Therefore, an output voltage and an output current of the control power source are more stable, which finally improves stability and reliability of the brushless DC motor under conditions such as a large output power (of above 800 w) and a long power cable (of more than 3 m).

These and other objectives, features, and advantages of the present invention will become apparent from the following detailed description, the accompanying drawings, and the appended claims.

### BRIEF DESCRIPTION OF THE DRAWINGS

FIG. 1 is a schematic view of the present invention.

FIG. 2 is a schematic view of a power source module of the present invention.

FIG. 3 is a schematic view of a driving module of the present invention.

### DETAILED DESCRIPTION OF THE PREFERRED EMBODIMENT

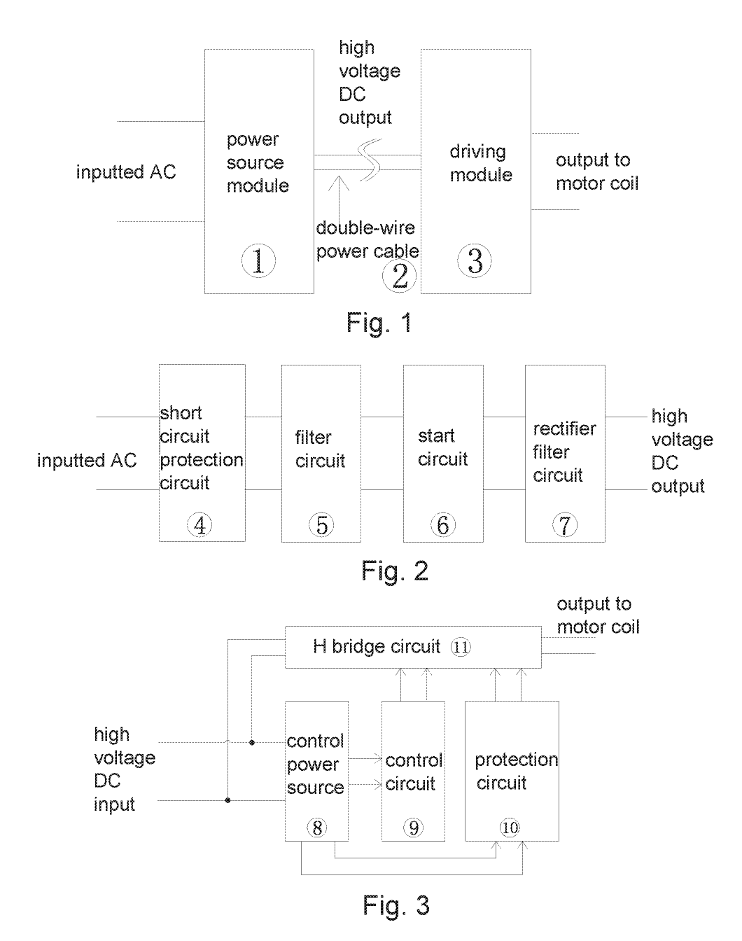

Referring to FIGS. 1-3, the present invention provides a power source device of an electric tool, comprising:

a power source module 1, comprising a short circuit protection circuit 4, a filter circuit 5, a start circuit 6 and a rectifier filter circuit 7, wherein the power source module 1 converts an inputted AC (alternating current) into a high voltage DC (direct current) through the short circuit protection circuit 4, the filter circuit 5, the start circuit 6 and the rectifier filter circuit 7;

a driving module 3, comprising an H bridge circuit 11, a control circuit 9, a protection circuit 10 and a control power source 8, wherein the driving module 3 divides the high voltage DC into a first DC and a second DC; the first DC is directly sent to the H bridge circuit 11 as a power source of a motor coil, and the H bridge circuit 11 outputs a voltage signal and a current signal for the motor coil according to a control signal; the second DC is sent to the control power source 8, then the control power source 8 converts the second DC into a low voltage DC, for supplying the control circuit 9 and the protection circuit 10; and

a power cable 2, respectively connected to the power source module 1 and the driving module 3, for sending the high voltage DC from the power source module 1 to the driving module 3.

Preferably, the power cable 2 is a double-wire power cable.

Preferably, the power source module 1 and the control power source 8 are separately placed.

Preferably, the control power source 8 is integrated in the driving module 3.

According to the present invention, the power source module 1 converts the inputted AC into the high voltage DC, and the high-voltage DC is sent to the driving module 3 through the double-wire power cable. Then the driving module 3 divides the high voltage DC into the first DC and the second DC, wherein the first DC is directly sent to the H bridge circuit 11 as the power source of the motor coil, and the H bridge circuit 11 outputs the voltage signal and the current signal for the motor coil according to the control signal; the second DC is sent to the control power source 8, then the control power source 8 converts the second DC into the low voltage DC, for supplying the control circuit 9 and the protection circuit 10. With the foregoing structure, a high voltage DC power source and a control power source are able to be placed separately, and the power source module 1 is connected to the driving module 3 only with the double-wire power cable, in such a manner that when the power cable 2 of a blushless DC motor is continuously pressed by an external force or cut by sharp metals and a short circuit happens inside the power cable 2, only the high voltage DC power source suffers from a short circuit, so as to effectively prevent the high voltage DC power source from entering low voltage circuits without lowering the voltage, which would immediately burn the control circuit 9 and the protection circuit 10 cases. Furthermore, because the control power source 8 is integrated in the driving module 3, the control power source 8 is no longer far from the control circuit 9 and the protection circuit 10, so as to effectively protect the control power source 8 from being affected by parasitic inductance and resistance on the power cable 2. Therefore, an output voltage and an output current of the control power source 8 are more stable, which finally improves stability and reliability of the brushless DC motor under conditions such as a large output power (of above 800 w) and a long power cable (of more than 3 m).

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A power source device of an electric tool, comprising:
a power source module, comprising a short circuit protection circuit, a filter circuit, a start circuit and a rectifier filter circuit, wherein the power source module converts an inputted AC (alternating current) into a high voltage DC (direct current) through the short circuit protection circuit, the filter circuit, the start circuit and the rectifier filter circuit;
a driving module, comprising an H bridge circuit, a control circuit, a protection circuit and a control power source, wherein the driving module divides the high voltage DC into a first DC and a second DC; the first DC is directly sent to the H bridge circuit as a power source of a motor coil, and the H bridge circuit outputs a voltage signal and a current signal for the motor coil according to a control signal; the second DC is sent to the control power source, then the control power source converts the second DC into a low voltage DC, for supplying the control circuit and the protection circuit; and
a power cable, respectively connected to the power source module and the driving module, for sending the high voltage DC from the power source module to the driving module.

2. The power source device, as recited in claim 1, wherein the power cable is a double-wire power cable.

3. The power source device, as recited in claim 1, wherein the power source module and the control power source are separately placed.

4. The power source device, as recited in claim 2, wherein the power source module and the control power source are separately placed.

5. The power source device, as recited in claim 1, wherein the control power source is integrated in the driving module.

6. The power source device, as recited in claim 2, wherein the control power source is integrated in the driving module.

7. The power source device, as recited in claim 3, wherein the control power source is integrated in the driving module.

8. The power source device, as recited in claim 4, wherein the control power source is integrated in the driving module.
